(19) United States
(12) Patent Application Publication
(10) Pub. No.: US 2020/0299533 A1
(43) Pub. Date: Sep. 24, 2020

(54) FLUORINATED ELASTOMERS CURED BY ACTINIC RADIATION AND METHODS THEREOF

(71) Applicant: 3M INNOVATIVE PROPERTIES COMPANY, St. Paul, MN (US)

(72) Inventors: Tho Q. Nguyen, Bloomington, MN (US); Tatsuo Fukushi, Woodbury, MN (US); Sheng Ye, Redmond, WA (US)

(21) Appl. No.: 16/763,606

(22) PCT Filed: Dec. 17, 2018
(86) PCT No.: PCT/US2018/065960

§ 371 Date: May 13, 2020

Related U.S. Application Data
(60) Provisional application No. 62/599,939, filed on Dec. 18, 2017.

(51) Int. Cl. C09D 127/16; C08K 5/00; C08K 5/14

(52) U.S. Cl. CPC C09D 127/16; C08K 2201/019; C08K 5/14; C08K 5/0025

(57) ABSTRACT

Described herein is a curable composition comprising an amorphous fluoropolymer having an iodine, bromine, and/or nitrile cure site; a peroxide cure system comprising a peroxide and a Type II coagent; and optionally carbon black, wherein the composition is substantially free of a photoinitiator selected from a Type I photoinitiator, a Type II photoinitiator, and/or a 3-component electron transfer initiating system. The curable composition is exposed to actinic radiation to at least partially cure the curable composition.

### TECHNICAL FIELD

The present disclosure relates to a composition comprising an amorphous fluoropolymer, wherein the amorphous fluoropolymer is at least partially cured using actinic radiation. Methods of making the fluorinated elastomer and cured fluoroelastomer articles are disclosed herein.

### SUMMARY

Peroxide cured fluorinated elastomers are known for their improved steam and chemical resistance as compared to fluorinated elastomers cured using other cure systems such as bisphenol or triazine. When curable compositions comprising an amorphous fluoropolymer and a peroxide curing system are thinly coated onto a substrate and thermally cured, it has been found that the coating is not sufficiently cured. Thus, it is desirable to identify a peroxide cured fluoroelastomer that is sufficiently cured when coated as a thin layer.

In one aspect, method of at least partially curing a fluoroelastomer is described, the method comprising:

(i) obtaining a composition comprising:
(a) an amorphous fluoropolymer having a plurality of cure sites wherein the cure sites comprise iodine, bromine, nitrile, or combinations thereof; and
(b) a peroxide cure system comprising a peroxide and a Type II coagent; and wherein the composition is substantially free of a photoinitiator, wherein the photoinitiator is selected from a Type I photoinitiator, a Type II photoinitiator, and a 3-component electron transfer initiator system; and

(ii) exposing at least a surface of the composition to actinic radiation.

In one embodiment, a method of curing an amorphous fluoropolymer with ultraviolet (UV) light is disclosed.

In one aspect, an article is disclosed wherein the article is made by at least partially curing a composition comprising:
(a) an amorphous fluoropolymer having a plurality of cure sites wherein the cure sites comprise iodine, bromine, nitrile, or combinations thereof; and
(b) a peroxide cure system comprising a peroxide and a Type II coagent, wherein the composition is substantially free of a photoinitiator, wherein the photoinitiator is selected from a Type I photoinitiator, a Type II photoinitiator, and a 3-component electron transfer initiator system and wherein at least a surface of the composition is exposed to actinic radiation.

In one aspect, a fluoroelastomer coating is described, wherein the fluoroelastomer coating has a thickness of at least 25 microns and at most 260 microns and the fluoroelastomer is a peroxide cured fluoroelastomer, optionally, comprising carbon black, which is substantially free of a photoinitiator, wherein the photoinitiator is selected from a Type I photoinitiator, a Type II photoinitiator, and a 3-component electron transfer initiator system.

The above summary is not intended to describe each embodiment. The details of one or more embodiments of the invention are also set forth in the description below. Other features, objects, and advantages will be apparent from the description and from the claims.

### DETAILED DESCRIPTION

As used herein, the term

“and/or” is used to indicate one or both stated cases may occur, for example A and/or B includes, (A and B) and (A or B);

“backbone” refers to the main continuous chain of the polymer;

“crosslinking” refers to connecting two pre-formed polymer chains using chemical bonds or chemical groups;

“cure site” refers to functional groups, which may participate in crosslinking;

“interpolymerized” refers to monomers that are polymerized together to form a polymer backbone;

“monomer” is a molecule which can undergo polymerization which then form part of the essential structure of a polymer;

“perfluorinated” means a group or a compound derived from a hydrocarbon wherein all hydrogen atoms have been replaced by fluorine atoms. A perfluorinated compound may however still contain atoms other than fluorine and carbon atoms, like oxygen atoms, chlorine atoms, bromine atoms and iodine atoms; and

“polymer” refers to a macrostructure having a number average molecular weight (Mn) of at least 50,000 dalton, at least 100,000 dalton, at least 300,000 dalton, at least 500,000 dalton, at least, 750,000 dalton, at least 1,000,000 dalton, or even at least 1,500,000 dalton and not such a high molecular weight as to cause premature gelling of the polymer.

Contrary to the use of “consisting”, the use of words such as “including,” “containing”, “comprising,” or “having” and variations thereof is meant to encompass the items listed thereafter and equivalents thereof as well as additional items.

As used herein, the phrase “comprising at least one of” followed by a list refers to comprising any one of the items in the list and any combination of two or more items in the list. The phrase “at least one of” followed by a list refers to any one of the items in the list or any combination of two or more items in the list.

Also herein, recitation of ranges by endpoints includes all numbers subsumed within that range (e.g., 1 to 10 includes 1.4, 1.9, 2.33, 5.75, 9.98, etc.).

Also herein, recitation of“at least one” includes all numbers of one and greater (e.g., at least 2, at least 4, at least 6, at least 8, at least 10, at least 25, at least 50, at least 100, etc.).

Disclosed herein is a curable fluoropolymer composition. This curable fluoropolymer composition is at least partially cured by exposure to actinic radiation. In one embodiment, the curable fluoropolymer composition is substantially cured via actinic radiation. In another embodiment, the curable fluoropolymer composition is first partially cured by exposure to actinic radiation and then subsequently exposed to a thermal treatment.

The curable fluoropolymer composition of the present disclosure comprises an amorphous fluoropolymer; a peroxide; a Type II coagent; and optionally, carbon black; and the curable fluoropolymer composition is substantially free of a photoinitiator, wherein the photoinitiator is selected from (a) Type I photoinitiator, (b) a Type II photoinitiator, and/or (c) a three-component electron transfer initiator.

The fluoropolymers of the present disclosure are amorphous, meaning that there is an absence of long-range order (i.e., in long-range order the arrangement and orientation of the macromolecules beyond their nearest neighbors is understood). The amorphous polymer has no detectable crystalline character by DSC (differential scanning calorimetry). If studied under DSC, the fluoropolymer would have no melting point or melt transitions with an enthalpy more than 0.002, 0.01, 0.1, or even 1 Joule/g from the second heat of a heat/cool/heat cycle, when tested using a DSC thermogram with a first heat cycle starting at −85° C. and ramped at 10° C./min to 350° C., cooling to −85° C. at a rate of 10° C./min and a second heat cycle starting from −85° C. and ramped at 10° C./min to 350° C.

The amorphous fluoropolymers of the present disclosure may be perfluorinated or partially fluorinated. A perfluorinated amorphous polymer comprises C—F bonds and no C—H bonds along the carbon backbone of the polymer chain, however, the terminal ends of the polymer, where the polymerization was initiator or terminated, may comprise C—H bonds. A partially fluorinated amorphous polymer comprises both C—F and C—H bonds along the carbon backbone of the polymer chain, excluding the terminal ends.

In one embodiment, the amorphous fluoropolymer of the present disclosure comprises at least 30%, 50%, 55%, 58%, or even 60% by weight of fluorine, and no more than 65, 70, 71, or even 73% by weight of fluorine (based on the total weight of the amorphous fluoropolymer).

In one embodiment, the amorphous fluoropolymer may be derived from one or more fluorinated monomer(s) such as tetrafluoroethylene (TFE), vinyl fluoride (VF), vinylidene fluoride (VDF), hexafluoropropylene (HFP), pentafluoropropylene, trifluoroethylene, trifluorochloroethylene (CTFE), perfluorovinyl ethers, perfluoroallyl ethers, and combinations thereof.

In one embodiment, perfluorovinyl ethers are of the formula I

CF₂=CFO(R_{f′}O)ₘR_{f} (I)

where R_{f″} is a linear or branched perfluoroalkylene radical groups comprising 2, 3, 4, 5, or 6 carbon atoms, m is an integer selected from 0, 1, 2, 3, 4, 5, 6, 7, 8, 9, and 10, and R_{f} is a perfluoroalkyl group comprising 1, 2, 3, 4, 5, or 6 carbon atoms. Exemplary perfluorovinyl ether monomers include: perfluoro (methyl vinyl) ether (PMVE), perfluoro (ethyl vinyl) ether (PEVE), perfluoro (n-propyl vinyl) ether (PPVE-1), perfluoro-2-propoxypropylvinyl ether (PPVE-2), perfluoro-3-methoxy-n-propylvinyl ether, perfluoro-2-methoxy-ethylvinyl ether, perfluoro-methoxy-methylvinylether (CF₃—O—CF₂—O—CF=CF₂), and CF₃—(CF₂)₂—O—CF(CF₃)—CF₂—O—CF(CF₃)—CF₂—O—CF=CF₂, and combinations thereof.

In one embodiment, perfluoroallyl ethers are of the formula II

CF₂=CFCF₂O(R_{f″}O)ₙ(R_{f′}O)ₘR_{f} (II)

where R_{f″} and R_{f′} are independently linear or branched perfluoroalkylene radical groups comprising 2, 3, 4, 5, or 6 carbon atoms, m and n are independently an integer selected from 0, 1, 2, 3, 4, 5, 6, 7, 8, 9, and 10, and R_{f} is a perfluoroalkyl group comprising 1, 2, 3, 4, 5, or 6 carbon atoms. Exemplary perfluoroallyl ether monomers include: perfluoro (ethyl allyl) ether, perfluoro (n-propyl allyl) ether, perfluoro-2-propoxypropyl allyl ether, perfluoro-3-methoxy-n-propylallyl ether, perfluoro-2-methoxy-ethyl allyl ether, perfluoro-methoxy-methyl allyl ether, and CF₃—(CF₂)₂—O—CF(CF₃)—CF₂—O—CF(CF₃)—CF₂—O—CF₂CF=CF₂, and combinations thereof.

The amorphous fluoropolymer during the polymer formation may be modified by the addition of small amounts of other copolymerizable monomers, which may or may not contain fluorine substitution, e.g. ethylene, propylene, butylene and the like. Generally, these additional monomers (i.e., comonomers) would be used at less than 25 mole percent of the fluoropolymer, preferably less than 10 mole percent, and even less than 3 mole percent.

Exemplary amorphous fluoropolymers include random copolymers such as: copolymers comprising TFE and perfluorinated vinyl ethers monomeric units (such as copolymers comprising TFE and PMVE, copolymers comprising TFE and CF₂=CFOC₃F₇, copolymers comprising TFE CF₂=CFOCF₃, and CF₂=CFOC₃F₇, and copolymers comprising TFE and PEVE); copolymers comprising TFE and perfluorinated allyl ethers monomeric units; copolymers comprising TFE and propylene monomeric units; copolymers comprising TFE, propylene, and VDF monomeric units; copolymers comprising VDF and HFP monomeric units; copolymers comprising TFE and HFP monomeric units; copolymers comprising TFE, VDF, and HFP monomeric units; copolymers comprising TFE and ethyl vinyl ether (EVE) monomeric units; copolymers comprising TFE and butyl vinyl ether (BVE) monomeric units; copolymers comprising TFE, EVE, and BVE monomeric units; copolymers comprising VDF and perfluorinated vinyl ethers monomeric units (such as copolymers comprising VDF and CF₂=CFOC₃F₇) monomeric units; copolymers comprising ethylene and HFP monomeric units; copolymers comprising CTFE and VDF monomeric units; copolymers comprising TFE and VDF monomeric units; copolymers comprising TFE, VDF and perfluorinated vinyl ethers monomeric units (such as copolymers comprising TFE, VDF, and PMVE) monomeric units; copolymers comprising VDF, TFE, and propylene monomeric units; copolymers comprising TFE, VDF, PMVE, and ethylene monomeric units; copolymers comprising TFE, VDF, and perfluorinated vinyl ethers monomeric units (such as copolymers comprising TFE, VDF, and CF₂=CFO(CF₂)₃OCF₃) monomeric units; and combinations thereof.

In one embodiment, the amorphous fluoropolymer comprises interpolymerized units derived from vinylidene fluoride (VDF). In one embodiment, the amorphous fluoropolymer is derived from 25-65 wt % VDF or even 35-60 wt % VDF.

In one embodiment, the amorphous fluoropolymer comprises interpolymerized units derived from (i) hexafluoropropylene (HFP), tetrafluoroethylene (TFE), and vinylidene fluoride (VDF); (ii) HFP and VDF, (iii) VDF and perfluoromethyl vinyl ether (PMVE), (iv) VDF, TFE, and PMVE, (v) VDF, TFE, and propylene, (vi) ethylene, TFE, and PMVE, (vii) TFE, VDF, PMVE, and ethylene, and (viii) TFE, VDF, and CF₂=CFO(CF₂)₃OCF₃.

In one embodiment, the amorphous fluoropolymer comprises interpolymerized units derived from at least 50, 55, or even 60 wt % and at most 65, 70, or even 75 wt % VDF; and at least 30 or even 35 wt % and at most 40, 45, or even 50 wt % HFP. In one embodiment, the amorphous fluoropolymer comprises interpolymerized units derived from at least 45, 50, 55, or even 60 wt % and at most 65, 70, or even 75 wt % VDF; at least 10, 15, or even 20 wt % and at most 30, 35, 40, or even 45 wt % HFP; and at least 3, 5, or even 7 wt % and at most 10 or even 15 wt % TFE. In one embodiment, the amorphous fluoropolymer comprises interpolymerized units derived from at least 25, 30, or even 35 wt % and at most 40, 45, 50, 55, or even 65 wt % VDF; at least 20, 25, or even 30 wt % and at most 35, 40, or even 45 wt % HFP; and at least 15, 20, or even 25 wt % and at most 30, 35, or even 40 wt % TFE. In one embodiment, the amorphous fluoropolymer comprises interpolymerized units derived from at least 30, 35, 40, or even 45 wt % and at most 55, 60, or even 65 wt % VDF; at least 25, 30, or even 35 wt % and at most 40, 45, 50, 55, 60, or even 65 wt % PMVE; and at least 3, 5, or even 7 wt % and at most 10, 15, or even 20 wt % TFE. In one embodiment, the amorphous fluoropolymer comprises interpolymerized units derived from at least 30, 35, 40, or even 45 wt % and at most 55, 60, or even 65 wt % VDF; at least 10, 15, 20, 25, or even 35 wt % and at most 40, 45, 50, 55, or even 60 wt % PMVE; and at least 10 15, or even 20 wt % and at most 25, 30, or even 35 wt % TFE. In one embodiment, the amorphous fluoropolymer comprises interpolymerized units derived from at least 5, 10, or even 15 wt % and at most 20, 25, or even 30 wt % VDF; at least 5, 10, or even 15 wt % and at most 20, 25, or even 30 wt % propylene; and at least 50, 55, 60, or even 65 wt % and at most 70, 75, 80, or even 85 wt % TFE. In one embodiment, the amorphous perfluorinated elastomer comprises interpolymerized units derived from at least 50, 60, or even 65 wt % and at most 70, 75 or even 80 wt % TFE and at least 20, 25, or even 30 wt % and at most 35, 40, 45, or even 50 wt % of a perfluorinated ether monomer as described above.

The amorphous fluoropolymer of the present disclosure contains cure sites which facilitate cross-linking of the fluoropolymer. These cure sites comprise at least one of iodine, bromine, and nitrile. The fluoropolymer may be polymerized in the presence of a chain transfer agent and/or cure site monomers to introduce cure sites into the fluoropolymer. Such cure site monomers and chain transfer agents are known in the art. Exemplary chain transfer agents include: an iodo-chain transfer agent, a bromo-chain transfer agent, or a chloro-chain transfer agent. For example, suitable iodo-chain transfer agent in the polymerization include the formula of RIₓ, where (i) R is a perfluoroalkyl or chloroperfluoroalkyl group having 3 to 12 carbon atoms; and (ii) x=1 or 2. The iodo-chain transfer agent may be a perfluorinated iodo-compound. Exemplary iodo-perfluoro-compounds include 1,3-diiodoperfluoropropane, 1,4-diiodoperfluorobutane, 1, 6-diiodoperfluorohexane, 1,8-diiodoperfluorooctane, 1,10-diiodoperfluorodecane, 1,12-diiodoperfluorododecane, 2-iodo-1,2-dichloro-1,1,2-trifluoroethane, 4-iodo-1,2,4-trichloroperfluorobutan, and mixtures thereof. In some embodiments, the iodo-chain transfer agent is of the formula I(CF₂)ₙ—O—R—(CF₂)ₘI, wherein n is 1, 2, 3, 4, 5, 6, 7, 8, 9, or 10, m is is 1, 2, 3, 4, 5, 6, 7, 8, 9, or 10 and Rᵣ is a partially fluorinated or perfluorinated alkylene segment, which can be linear or branched and optionally comprises at least one catenated ether linkage. Exemplary compounds include: I—CF₂—CF₂—O—CF₂—CF₂—I, I—CF(CF₃)—CF₂—O—CF₂—CF₂—I, I—CF₂—CF₂—O—CF(CF₃)—CF₂—O—CF₂—CF₂—I, I—(CF(CF₃)—CF₂—O)₂—CF₂—CF₂—I, I—CF₂—CF₂—O—(CF₂)₂—O—CF₂—CF₂—I, I—CF₂—CF₂—O—(CF₂)₃—O—CF₂—CF₂—I, and I—CF₂—CF₂—O—(CF₂)₄—O—CF₂—CF₂—I, I—CF₂—CF₂—CF₂—O—CF₂—CF₂—I, and I—CF₂—CF₂—CF₂—O—CF(CF₃)—CF₂—O—CF₂—CF₂—I, In some embodiments, the bromine is derived from a brominated chain transfer agent of the formula: RBrₓ, where (i) R is a perfluoroalkyl or chloroperfluoroalkyl group having 3 to 12 carbon atoms; and (ii) x=1 or 2. The chain transfer agent may be a perfluorinated bromo-compound.

Cure site monomers, if used, comprise at least one of a bromine, iodine, and/or nitrile cure moiety.

In one embodiment, the cure site monomers may be of the formula: a) CX₂=CX(Z), wherein: (i) X each is independently H or F; and (ii) Z is I, Br, R_{f}—U wherein U=I or Br and R_{f}=a perfluorinated or partially perfluorinated alkylene group optionally containing ether linkages or (b) Y(CF₂)_{q}Y, wherein: (i) Y is Br or I or Cl and (ii) q=1-6. In addition, non-fluorinated bromo- or iodo-olefins, e.g., vinyl iodide and allyl iodide, can be used. Exemplary cure site monomers include: CH₂=CHI, CF₂=CHI, CF₂=CFI, CH₂—CHCH₂I, CF₂=CFCF₂I, ICF₂CF₂CF₂CF₂I, CH₂—CHCF₂CF₂I, CF₂=CFCH₂CH₂I, CF₂—CFCF₂CF₂I, CH₂=CH(CF₂)₆CH₂CH₂I, CF₂=CFOCF₂CF₂I, CF₂=CFOCF₂CF₂CF₂I, CF₂=CFOCF₂CF₂CH₂I, CF₂=CFCF₂OCH₂CH₂I, CF₂=CFO(CF₂)₃—OCF₂CF₂I, CH₂=CHBr, CF₂—CHBr, CF₂=CFBr, CH₂=CHCH₂Br, CF₂=CFCF₂Br, CH₂—CHCF₂CF₂Br, CF₂=CFOCF₂CF₂Br, CF₂—CFCl, I—CF₂—CF₂CF₂—O—CF=CF₂, I—CF₂—CF₂CF₂—O—CF₂CF=CF₂, I—CF₂—CF₂—O—CF₂—CF=CF₂, I—CF(CF₃)—CF₂—O—CF=CF₂, I—CF(CF₃)—CF₂—O—CF₂—CF=CF₂, I—CF₂—CF₂—O—CF(CF₃)—CF₂—O—CF=CF₂, I—CF₂—CF₂—O—CF(CF₃)—CF₂—O—CF₂—CF=CF₂, I—CF₂—CF₂—(O—(CF(CF₃)—CF₂)₂—O—CF=CF₂, I—CF₂—CF₂—(O—(CF(CF₃)—CF₂)₂—O—CF₂—CF=CF₂, Br—CF₂—CF₂—O—CF₂—CF=CF₂, Br—CF(CF₃)—CF₂—O—CF=CF₂, I—CF₂—CF₂—CF₂—O—CF(CF₃)—CF₂—O—CF=CF₂, I—CF₂—CF₂—CF₂—O—CF(CF₃)—CF₂—O—CF₂—CF=CF₂, I—CF₂—CF₂—CF₂—(O—(CF(CF₃)—CF₂)₂—O—CF=CF₂, I—CF₂—CF₂—CF₂—O—(CF(CF₃)—CF₂—O)₂—CF₂—CF=CF₂, Br—CF₂—CF₂—CF₂—O—CF=CF₂, Br—CF₂—CF₂—CF₂—O—CF₂—CF=CF₂, I—CF₂—CF₂—O—(CF₂)₂—O—CF=CF₂, I—CF₂—CF₂—O—(CF₂)₃—O—CF=CF₂, I—CF₂—CF₂—O—(CF₂)₄—O—CF=CF₂, I—CF₂—CF₂—O—(CF₂)₂—O—CF₂—CF=CF₂, I—CF₂—CF₂—O—(CF₂)₃—O—CF₂—CF=CF₂, I—CF₂—CF₂—O—(CF₂)₂—O—CF(CF₃)CF₂—O—CF₂=CF₂, I—CF₂—CF₂—O—(CF₂)₂—O—CF(CF₃)CF₂—O—CF₂—CF₂=CF₂, Br—CF₂—CF₂—O—(CF₂)₂—O—CF═CF₂, Br—CF₂—CF₂—O—(CF₂)₃—O—CF=CF₂, Br—CF₂—CF₂—O—(CF₂)₄—O—CF=CF₂, and Br—CF₂—CF₂—O—(CF₂)₂—O—CF₂—CF=CF₂.

In another embodiment, the cure site monomers comprise nitrile-containing cure moieties. Useful nitrile-containing cure site monomers include nitrile-containing fluorinated olefins and nitrile-containing fluorinated vinyl ethers, such as: perfluoro(8-cyano-5-methyl-3,6-dioxa-1-octene); CF₂=CF—O—(CF₂)ₙ—CN where n=2-12, preferably 2, 3, 4, 5, or 6. Examples of a nitrile-containing cure site monomer include CF₂—CF—O—[CF₂—CFCF₃—O]ₙ—CF₂—CF(CF₃)—CN; where n is 0, 1, 2, 3, or 4, preferably 0, 1, or 2; CF₂=CF—[OCF₂CF(CF₃)]ₓ—O—(CF₂)ₙ—CN; where x is 1 or 2, and n is 1, 2, 3, or 4; and CF₂=CF—O—(CF₂)ₙ—O—CF(CF₃)CN where n is 2, 3, or 4. Exemplary nitrile-containing cure site monomers include: CF₂=CFO(CF₂)₅CN, CF₂=CFOCF₂CF(CF₃)OCF₂CF₂CN, CF₂=CFOCF₂CF(CF₃)OCF₂CF(CF₃)CN, CF₂=CFOCF₂CF₂CF₂OCF(CF₃)CN, CF₂=CFOCF₂CF(CF₃)OCF₂CF₂CN; and combinations thereof.

The amorphous fluoropolymer composition of the present disclosure comprises iodine, bromine, and/or nitrile cure sites, which may be used in the presence of a peroxide to crosslink the amorphous fluoropolymer. In one embodiment, the amorphous fluoropolymer composition of the present disclosure comprises at least 0.1, 0.5, 1, 2, or even 2.5 wt % of iodine, bromine, and/or nitrile groups versus the total weight of the amorphous fluoropolymer. In one embodiment, the amorphous fluoropolymer of the present disclosure comprises no more than 3, 5, or even 10 wt % of iodine, bromine, and/or nitrile groups versus the total weight of the amorphous fluoropolymer.

In one embodiment, the amorphous fluoropolymer comprising cure sites is blended with a second polymer. The second polymer may be a fluoroplastic or an amorphous fluoropolymer, which may or may not comprise bromine, iodine, and/or nitrile cure sites. In one embodiment, the second polymer is a perfluoroalkoxy alkane polymer derived from (i) TFE and (ii) perfluorovinyl ethers and/or perfluoroallyl ethers as disclosed above. In one embodiment, the compositions of the present disclosure are substantially free (i.e., comprise less than 1% by weight) of acrylates and methacrylates or other non-fluorinated polymers which traditionally undergo ultraviolet curing.

The compositions of the present disclosure comprise a peroxide cure system, which includes a peroxide and a Type II coagent.

In one embodiment, the peroxide is an organic peroxide, preferably, a tertiary butyl peroxide having a tertiary carbon atom attached to peroxy oxygen.

Exemplary peroxides include: benzoyl peroxide, dicumyl peroxide, di-tert-butyl peroxide, 2,5-di-methyl-2,5-di-tert-butylperoxyhexane, 2,4-dichlorobenzoyl peroxide, 1,1-bis(tert-butylperoxy)-3,3,5-trimethylchlorohexane, tert-butyl peroxy isopropylcarbonate (TBIC), tert-butyl peroxy 2-ethylhexyl carbonate (TBEC), tert-amyl peroxy 2-ethylhexyl carbonate, tert-hexylperoxy isopropyl carbonate, carbonoperoxoic acid, O,O′-1,3-propanediyl OO,OO′-bis(1,1-dimethylethyl) ester, tert-butylperoxy benzoate, t-hexyl peroxy-2-ethylhexanoate, t-butyl peroxy-2-ethylhexanoate, di(4-methylbenzoyl) peroxide, laurel peroxide and cyclohexanone peroxide. Other suitable peroxide curatives are listed in U.S. Pat. No. 5,225,504 (Tatsu et al.).

The amount of peroxide used generally will be at least 0.1, 0.2, 0.4, 0.6, 0.8, 1, 1.2, or even 1.5; at most 2, 2.25, 2.5, 2.75, 3, 3.5, 4, 4.5, 5, or even 5.5 parts by weight per 100 parts of the amorphous fluoropolymer.

Coagents are reactive additives used to improve the peroxide curing efficiency by rapidly reacting with radicals and potentially suppressing side reactions and/or generating additional crosslinks. Coagents can be classified as Type I or Type II based on their contributions to the cure. Type I coagents are typically polar, multifunctional low molecular weight compounds which form very reactive radicals through addition reactions. Type I coagents can be readily homopolymerized and form crosslinks through radical addition reactions. Exemplary Type I coagents include multifunctional acrylate and methacrylate esters and dimaleimides. Type II coagents form less reactive radicals and contribute only to the state of cure. The coagent forms a radical through hydrogen abstraction or addition of a radical from the peroxide. These coagent radicals can then react with the fluoropolymer through the Br, I, and/or CN sites. Type II coagents comprising an allylic hydrogen tend to participate in intramolecular cyclization reactions as well as intermolecular propagation reactions. The peroxide cure system of the present disclosure comprises a peroxide and a Type II coagent. In one embodiment, the peroxide cure system of the present disclosure is substantially free of a Type I coagent, meaning that less than 5, 2, 1, 0.5, or even 0.1 wt % or even none of a Type I coagent is present versus the weight of the amorphous fluoropolymer. In one embodiment, the curable compositions of the present disclosure are substantially free (i.e., comprise less than 5, 2, 1, 0.5, 0.1 wt % or even none) of an unsaturated metal coagent of the formula Y₍₄₋ₙ₎MXₙ where Y is selected from alkyl, aryl, carboxylic acid, or alkyl ester groups, M is Si, Ge, Sn, or Pb, X is an allyl, vinyl, alkyenyl, or propargyl group, and n is 1, 2, or 3.

As used herein, a Type II coagent refers to multifunctional polyunsaturated compound, which are known in the art and include allyl-containing cyanurates, isocyanurates, and phthalates, homopolymers of dienes, and co-polymers of dienes and vinyl aromatics. A wide variety of useful Type 11 coagents are commercially available including di- and triallyl compounds, divinyl benzene, vinyl toluene, vinyl pyridine, 1,2-cis-polybutadiene and their derivatives. Exemplary Type II coagents include a diallyl ether of glycerin, triallylphosphoric acid, diallyl adipate, diallylmelamine and triallyl isocyanurate (TAIC), tri(methyl)allyl isocyanurate (TMAIC), tri(methyl)allyl cyanurate, poly-triallyl isocyanurate (poly-TAIC), xylylene-bis(diallyl isocyanurate) (XBD), N,N′-m-phenylene bismaleimide, diallyl phthalate, tris(diallylamine)-s-triazine, triallyl phosphite, 1,2-polybutadiene, ethyleneglycol diacrylate, diethyleneglycol diacrylate, and combinations thereof. Exemplary partially fluorinated compounds comprising two terminal unsaturation sites include: CH₂—CH—R_{f1}—CH═CH₂ wherein R_{f1} may be a perfluoroalkylene of 1 to 8 carbon atoms.

The amount of Type II coagent used generally will be at least 0.1, 0.5, or even 1 part by weight per 100 parts of amorphous fluoropolymer; and at most 2, 2.5, 3, or even 5 parts by weight per 100 parts of amorphous fluoropolymer.

In one embodiment, the amorphous fluoropolymer composition of the present disclosure comprises carbon black. Exemplary types of carbon black include medium thermal carbon black such as N990 and N991; super abrasion furnace such as N110; high abrasion furnace such as N330 and N326; fast extruding furnace such as N550 and N650; semi-reinforcing furnace such as N774 and N762; Austin black; and a renewable carbonaceous material sold under the trade designation “NEAT90” from CarbonNeat, Cornelius, N.C. Depending on the type of carbon black used, the average particle size can range for example, from at least 15, 20, or even 30 nm to at most 35, 40, 45, 50, or even 60 nm; from at least 40, 50, or even 60 nm to at most 70, 80, 90, or even 100 nm; and from at least 150 nm, 180, or even 190 nm to at most 200, 250, 300, 350, or even 400 nm. In one embodiment, the carbon black content is at least 0.01, 0.1, 1, 5, or even 10% and at most 15, 20, 30, 40, or even 50% by weight based on the total weight of the composition. Although not wanting to be bound by theory, it is believed that the presence of carbon black may aid in the peroxide curing of the amorphous fluoropolymer by absorbing the actinic radiation and converting it to heat to initiate the peroxide cure reaction.

The amorphous fluoropolymer composition of the present disclosure is substantially free of(i) a Type I photoinitiator, (ii) a Type II photoinitiator, and/or (iii) 3-component electron transfer initiator system. Substantially free of these photoinitiators means that these compounds are present at low enough amounts so as not to cause curing of the composition upon exposure to actinic radiation. In one embodiment, the composition comprises less than 0.1, 0.05, 0.01, or even 0.001% by weight of (i) a Type I photoinitiator, (ii) a Type II photoinitiator, and/or (iii) the photosensitizer of a 3-component electron transfer initiator system versus the amount of amorphous fluoropolymer.

It has been discovered that the curable compositions of the present disclosure, while not comprising (i) a Type I photoinitiator, (ii) a Type II photoinitiator, and/or (iii) 3-component electron transfer initiator system, are still able to at least partially crosslink the fluoropolymer upon exposure to actinic radiation.

Type I and Type II photoinitiators are known in the art. Type I photoinitiators work via an alpha-cleavage which forms two radical species. At least one of the radical species initiates polymerization of the monomer(s). Exemplary Type I photoinitiators include benzoin ethers such as benzoin methyl ether and benzoin isopropyl ether; substituted acetophenones such as 2, 2-dimethoxyacetophenone, available under the trade designation “IRGACURE™ 651” photoinitiator (Ciba Specialty Chemicals), 2,2 dimethoxy-2-phenyl-1-phenylethanone, available under the trade designation “ESACURE KB-1” photoinitiator (Sartomer Co.; West Chester, Pa.), 1-[4-(2-hydroxyethoxy)phenyl]-2-hydroxy-2-methyl-1-propan-1-one, available under the trade designation “IRGACURE 2959” (Ciba Specialty Chemicals), and dimethoxyhydroxyacetophenone; substituted α-ketols such as 2-methyl-2-hydroxy propiophenone; aromatic sulfonyl chlorides such as 2-naphthalene-sulfonyl chloride; and photoactive oximes such as 1-phenyl-1,2-propanedione-2-(O-ethoxy-carbonyl)oxime. Particularly preferred among these are the substituted acetophenones, and especially 1-[4-(2-hydroxyethoxy)phenyl]-2-hydroxy-2-methyl-1-propan-1-one due to its water solubility.

Type II photoinitiators comprise a photoinitiator, which upon absorption of energy, facilitate hydrogen abstraction from a second entity (e.g., co-initiator) having an abstractable functional groups (such as an alcohol or an amine) provide an incipient free radical. Exemplary Type II photoinitiators include benzophenone, 4-(3-sulfopropyloxy)benzophenone sodium salt, Michler's ketone, benzil, anthraquinone, 5,12-naphthacenequinone, aceanthracenequinone, benz(A)anthracene-7,12-dione, 1,4-chrysenequinone, 6,13-pentacenequinone, 5,7,12,14-pentacenetetrone, 9-fluorenone, anthrone, xanthone, thioxanthone, 2-(3-sulfopropyloxy)thioxanthen-9-one, acridone, dibenzosuberone, acetophenone, and chromone.

A three-component electron transfer initiator system is known in the art and typically includes (i) photosensitizer, (ii) an iodonium salt and (iii) an electron donor as described in U.S. Pat. No. 5,545,676 (Palazzotto, et al.), herein incorporated by reference with respect to the various components.

The photosensitizer is capable of electromagnetic radiation absorption somewhere within the range of the wavelength(s) of interest (for example if the actinic radiation is in the UV range, the photosensitizer should absorb wavelengths within the UV range). Suitable photosensitizers are believed to include compounds in the following categories: ketones, coumarin dyes (e.g., ketocoumarins), xanthene dyes, acridine dyes, thiazole dyes, thiazine dyes, oxazine dyes, azine dyes, aminoketone dyes, porphyrins, aromatic polycyclic hydrocarbons, p-substituted aminostyryl ketone compounds, aminotriaryl methanes, merocyanines, squarylium dyes and pyridinium dyes. Ketones (e.g., monoketones or alpha-diketones), ketocoumarins, aminoarylketones and p-substituted aminostyryl ketone compounds are preferred sensitizers. An exemplary photosensitizer includes 2-isopropylthioxanthone; 2-chlorothioxanthone (ITX); and 9,10-dibutoxyanthracene. Suitable iodonium salts are described in U.S. Pat. Nos. 3,729,313, 3,741,769, 3,808,006, 4,250,053 and 4,394,403, the iodonium salt disclosures of which are incorporated herein by reference. The iodonium salt can be a simple salt (e.g., containing an anion such as Cl⁻, Br⁻, I⁻ or C₄HsSO₃⁻) or a metal complex salt (e.g., containing SbF₅OH⁻ or AsF₆⁻). Mixtures of iodonium salts can be used if desired. Preferred electron donor compounds include amines (including aminoaldehydes and aminosilanes), ascorbic acid and its salts. The donor can be unsubstituted or substituted with one or more non-interfering substituents. Particularly preferred donors contain an electron donor atom such as a nitrogen, oxygen, phosphorus, or sulfur atom, and an abstractable hydrogen atom bonded to a carbon or silicon atom alpha to the electron donor atom. Preferred amine donor compounds include alkyl-, aryl-, alkaryl- and aralkyl-amines such as triethanolamine,N,N′-dimethylethylenediamine, p-N N-dimethyl-aminophenethanol; aminoaldehydes such as p-N,N-dimethylaminobenzaldehyde, p-N,N-diethylaminobenzaldehyde, and 4-morpholinobenzaldehyde and suitable ether donor compounds include 4,4′-dimethoxybiphenyl, 1,2,4-trimethoxybenzene and 1,2,4,5-tetramethoxybenzene.

In one embodiment, the compositions of the present disclosure comprise additional components, which facilitate the processing or final properties of the resulting article.

For the purpose of, for example, enhancing the strength or imparting the functionality, conventional adjuvants, such as, for example, fillers, acid acceptors, process aids, or colorants may be added to the curable composition.

Exemplary fillers include: an organic or inorganic filler such as clay, silica (SiO₂), alumina, iron red, talc, diatomaceous earth, barium sulfate, wollastonite (CaSiO₃), calcium carbonate (CaCO₃), calcium fluoride, titanium oxide, iron oxide, graphite, carbon fibers, and carbon nanotubes, silicon carbide, boron nitride, molybdenum sulfide, high temperature plastics, an electrically conductive filler, a heat-dissipating filler, and the like may be added as an optional additive to the composition. High temperature plastics may be added to the curable composition to decrease cost, improve processing, and/or improve final product performance. These high temperature plastics have a melting point above the thermal treatment temperature. In one embodiment, the high temperature plastics have a melting point of at least 100, 120, or even 150° C. and at most 250, 300, 320, 350, or even 400° C. The high temperature plastics may be partially fluorinated polymers (e.g., copolymers of ethylene and chlorotrifluoroethylene; poly-VDF, or copolymers of TFE, HFP, and VDF); perfluorinated polymers (e.g., fluorinated ethylene propylene polymers, and perfluorinated alkoxy polymers (PFA); or non-fluorinated polymers (e.g., polyamide, polyaramid, polybenzimidazol, polyether ether ketone, polyphenylene sulfide). Such high temperature thermoplastics are described in WO 2011/035258 (Singh et al.). Those skilled in the art are capable of selecting specific fillers at required amounts to achieve desired physical characteristics in the vulcanized compound. The filler components may result in a compound that is capable of retaining a preferred elasticity and physical tensile, as indicated by an elongation and tensile strength value, while retaining desired properties such as retraction at lower temperature (TR-10).

In one embodiment, the filler content is between is at least 0.01, 0.1, 1, 5, or even 10% and at most 15, 20, 30, 40, or even 50% by weight based on the total weight of the composition.

Conventional adjuvants may also be incorporated into the composition of the present disclosure to enhance the properties of the resulting composition and/or the cured article. For example, acid acceptors may be employed to facilitate the cure and thermal stability of the compound. Suitable acid acceptors may include magnesium oxide, lead oxide, calcium oxide, calcium hydroxide, dibasic lead phosphite, zinc oxide, barium carbonate, strontium hydroxide, calcium carbonate, hydrotalcite, alkali stearates, magnesium oxalate, or combinations thereof. The acid acceptors are preferably used in amounts ranging from about 1 to about 20 parts per 100 parts by weight of the amorphous fluoropolymer.

The additives described above may be selected to alter the properties of the resulting article and/or not interfere with the curing of the composition using actinic radiation. In one embodiment, the filler is transparent. In one embodiment, the filler has a particle size of less than 500 μm, preferably less than 50 μm or even less than 5 μm.

The curable compositions of the present disclosure may comprise a solvent. A solvent can be used to adjust the viscosity of the curable composition to facilitate, for example, coating of the curable composition.

In one embodiment, the curable composition is a solution or liquid dispersion containing the amorphous fluoropolymer, the peroxide cure system, optional carbon black, optional additives, and a solvent such as water, ketone (e.g., acetone, methyl ethyl ketone, methyl isobutyl ketone), ether (e.g., diethyl ether, tetrahydrofuran), ester (e.g., ethyl acetate, butyl acetate), and fluorinated inert solvents (e.g., fluorinated solvents such as those available under the trade designation “3M FLUOROINERT ELECTRONIC LIQUID” and “3M NOVEC ENGINEERED FLUID” from 3M Co., St. Paul, Minn.). In one embodiment, the solvent is a partially fluorinated ether or polyether as disclosed in EP Appl. No. 16203046.4 (filed 8 Dec. 2016), incorporated by reference. In one embodiment, when a solvent is used, it is at least 40, 50, or even 60%, and at most 70, 80 or even 90% by weight of the solvent versus the total weight of the composition.

In one embodiment, the curable composition is substantially free of solvent (i.e., less than 5, 1 or even 0.5% by weight based on the total weight of the curable composition).

In one embodiment, the amorphous fluoropolymer content of the curable compositions is preferably as high as possible, for example, at concentrations from at least 50, 75, 80, 85, or even 90% by weight; and at most 95, 98, 99, or even 99.5% by weight based on the total weight of the curable composition.

In one embodiment, the curable composition of the present disclosure consists essentially of:
(a) an amorphous fluoropolymer having an iodine, bromine and/or nitrile cure site;
(b) a peroxide cure system comprising a peroxide and a Type II coagent; and
(c) optionally, carbon black,
wherein the curable composition is substantially free of a photoinitiator, wherein the photoinitiator is selected from a Type I photoinitiator, a Type II photoinitiator, and/or a 3-component electron transfer initiator system.
   The phrase “consists essentially of” means that the composition comprises the elements listed and may include additional elements not listed so long as they do not materially affect the composition. In other words, if all traces of the non-listed element were removed, the processing (e.g., curing time, extrusion rate, etc.) and final product characteristics (e.g., chemical and thermal resistance, hardness, etc.) of the composition would remain unchanged.

In one embodiment, the curable composition of the present disclosure comprises:
(a) an amorphous fluoropolymer having an iodine, bromine and/or nitrile cure site;
(b) a peroxide cure system comprising a peroxide and a Type II coagent; and
(c) optionally, carbon black; wherein the total weight of elements (a), (b), and (c) comprise at least 95, 98, 99.0, 99.5, or even 99.9% by weight versus the total weight of the curable composition; and wherein the curable composition is substantially free of a photoinitiator, wherein the photoinitiator is selected from a Type I photoinitiator, a Type II photoinitiator, and/or a 3-component electron transfer initiator system.

The curable composition comprising the amorphous fluoropolymer, the peroxide cure system, optional carbon black, optional additives, and optional solvent is at least partially cured using actinic radiation. Actinic radiation includes electromagnetic radiation in the ultraviolet, visible, and/or infrared wavelengths.

As used herein, actinic radiation refers to electromagnetic radiation in the ultraviolet, visible, and/or infrared wavelengths. In one embodiment, the curable composition is exposed to wavelengths from at least 180, 200, 210, 220, 240, 260, or even 280 nm; and at most 700, 800, 1000, 1200, or even 1500 nm. In one embodiment, the curable composition is exposed to wavelengths from at least 180, 210, or even 220 nm; and at most 340, 360, 380, 400, 410, 450, or even 500 nm. In one embodiment, the curable composition is exposed to wavelengths from at least 400, 420, or even 450 nm; and at most 700, 750, or even 800 nm. In one embodiment, the curable composition is exposed to wavelengths from at least 800, 850, or even 900 nm; and at most 1000, 1200, or even 1500 nm.

Any light source, may be employed as a radiation source, such as, a high or low pressure mercury lamp, a cold cathode tube, a black light, a light emitting diode, a laser, and/or a flash light. Of these, the preferred source is one exhibiting a relatively long wavelength UV-contribution having a dominant wavelength of 300-400 nm. UV radiation is generally classed as UV-A, UV-B, and UV-C as follows: UV-A: 400 nm to 320 nm; UV-B: 320 nm to 290 nm; and UV-C: 290 nm to 100 nm.

In one embodiment, the power of the actinic radiation is 10 to 1000 watts, which can depend on the radiation source used and any filters used. In one embodiment, the power of the actinic radiation is 10 to 100 watts. In another embodiment, the power of the actinic radiation is 200 to 600 watts.

In one embodiment, the intensity of the actinic radiation is at least 0.2, 0.3, 0.5, or even 1 watt/cm²; and at most 3, 5, 8, 10, or even 15 watts/cm².

When thermally curing with peroxides, the curable composition is typically heated above the decomposition temperature of the peroxide. In some embodiments, this decomposition temperature is above the boiling point of the peroxide. Although not wanting to be limited by theory, it is hypothesized that peroxides at the surface of the curable composition can evaporate reducing their presence at the surface. Alternatively, or additionally, because thermal heating tends to be slow, if the rate of radical generation is slow, a peroxide radical generated at the surface may react with oxygen present in the surrounding environment, causing termination of the radical species before crosslinking reactions occur.

Unexpectedly, it is presently discovered that peroxide curable fluoropolymer compositions can be at least partially cured upon exposure to actinic radiation in the absence of a Type I photoinitiator, a Type II photoinitiator, and/or a 3-component electron transfer initiator system. As used herein, partially cured refers to a state that the crosslinking degree in the fluoropolymer is higher than that in an uncrosslinked fluoropolymer (or polymer not exposed to actinic radiation), which can be observed by an increase in the viscosity of the fluoropolymer (such as modulus or torque increase using a UV rheometer) and/or by gelling during the Gel Test as disclosed below.

In one embodiment, the peroxide does not substantially absorb in the wavelength of interest. For example, in one embodiment, the peroxide is substantially free of an aromatic ring, yet the composition may at least partially cure using ultraviolet and/or visible radiation (e.g., wavelengths of 100-600 nm). In one embodiment, if the actinic radiation source emits wavelengths from 200 to 600 nm, the neat peroxide transmits greater than 90, 95, or even 99% in that wavelength range with a 1-cm path length.

Unexpectedly, the curable composition is able to be cured in the absence of a press cure. Typically, to cure peroxide curable polymeric compositions, the compositions are placed in a mold and pressure and heat is used to initially cure the composition. In one embodiment, the curable composition is able to be cured under ambient pressure conditions during the exposure to actinic radiation.

In one embodiment, during the exposure to actinic radiation, the curable composition is in an environment substantially free of oxygen (i.e., comprising less than 500, 200, or even 100 ppm of oxygen).

In one embodiment, the curable composition is first exposed to the actinic radiation which partially cures the composition (for example, there is at least 5, 10, or even 15% gelling when tested following the Gel Test Method disclosed herein), then the partially cured composition is exposed to a thermal treatment step. In one embodiment, the partially cured composition in the subsequent thermal treatment step is exposed to temperatures at least 60, 80, or even 100° C.; and most 200, 250, or even 300° C. for up to 5 hrs. In the thermal treatment step, the composition is exposed to a heat source, such as a hot plate, oven, hot air, hot press and the like, which causes the peroxide to undergo thermal degradation, which generates radicals, that subsequently cure the bulk of the fluoropolymer.

In one embodiment, the curable composition is coated onto a substrate and then exposed to actinic radiation. For example, the curable composition is coated onto a substrate using techniques known in the art including, for example, dip coating, spray coating, spin coating, blade or knife coating, bar coating, roll coating, and pour coating (i.e., pouring a liquid onto a surface and allowing the liquid to flow over the surface)). Substrates may include, metals (such as carbon steel, stainless steel, and aluminum), plastics (such as polyethylene, or polyethylene terephthalate), or release liners, which are a temporary support comprising a backing layer coated with a release agent (such as a silicone, fluoropolymer, or polyurethane). The composite comprising the substrate and a layer of curable composition is then exposed to actinic radiation to at least partially cure the curable composition. In one embodiment, a thin coating of the curable composition is disposed on a substrate, for example a dry coating thickness of at least 1, 5, or even 10 μm and at most 20, 50, 100, 200, or even 300 μm. In one embodiment, the thin coating is substantially crosslinked with the actinic radiation, meaning that when tested following the Gel Test Method described below, there is at least 65, 70, 80, or even 90% gelling.

Exemplary embodiments of the present disclosure include, but are not limited to the following:

### Embodiment 1

A method of at least partially curing a fluoroelastomer, the method comprising:

(i) obtaining a composition comprising:
(a) an amorphous fluoropolymer having a plurality of cure sites wherein the cure sites comprise iodine, bromine, nitrile, or combinations thereof; and
(b) a peroxide cure system comprising a peroxide and a Type II coagent; wherein the composition is substantially free of a photoinitiator, wherein the photoinitiator is selected from a Type I photoinitiator, a Type II photoinitiator, and a 3-component electron transfer initiator system; and

(ii) exposing at least a surface of the composition to actinic radiation.

### Embodiment 2

The method of embodiment 1, wherein the composition further comprises carbon black.

### Embodiment 3

The method of any one of the previous embodiments, wherein the amorphous fluoropolymer comprises at least 0.1 weight % of iodine versus the total weight of the amorphous fluoropolymer.

### Embodiment 4

The method of any one of the previous embodiments, wherein the amorphous fluoropolymer comprises at least 0.1 weight % of bromine versus the total weight of the amorphous fluoropolymer.

### Embodiment 5

The method of any one of the previous embodiments, wherein the amorphous fluoropolymer is partially fluorinated.

### Embodiment 6

The method of any one of the previous embodiments, wherein the amorphous fluoropolymer is a copolymer of wherein the amorphous fluoropolymer comprises (i) a copolymer comprising hexafluoropropylene, tetrafluoroethylene, and vinylidene fluoride monomeric units; (ii) a copolymer comprising hexafluoropropylene and vinylidene fluoride monomeric units, (iii) a copolymer comprising vinylidene fluoride and perfluoromethyl vinyl ether monomeric units, (iv) a copolymer comprising vinylidene fluoride, tetrafluoroethylene, and perfluoromethyl vinyl ether monomeric units, (v) a copolymer comprising vinylidene fluoride, tetrafluoroethylene, and propylene monomeric units, (vi) a copolymer comprising ethylene, tetrafluoroethylene, and perfluoromethyl vinyl ether monomeric units, and (vii) blends thereof.

### Embodiment 7

The method of any one of embodiments 1-5, wherein the amorphous fluoropolymer is perfluorinated.

### Embodiment 8

The method of any one of the previous embodiments, wherein the peroxide is at least one of 2,5-dimethyl-2,5-di(t-butylperoxy)hexane; dicumyl peroxide; di(2-t-butylperoxyisopropyl)benzene; dialkyl peroxide; bis (dialkyl peroxide); 2,5-dimethyl-2,5-di(tertiarybutylperoxy)3-hexyne; dibenzoyl peroxide; 2,4-dichlorobenzoyl peroxide; tertiarybutyl perbenzoate; α,α′-bis(t-butylperoxy-diisopropylbenzene); t-butyl peroxy isopropylcarbonate, t-butyl peroxy 2-ethylhexyl carbonate, t-amyl peroxy 2-ethylhexyl carbonate, t-hexylperoxy isopropyl carbonate, di[1,3-dimethyl-3-(t-butylperoxy)butyl] carbonate, carbonoperoxoic acid, or O,O′-1,3-propanediyl OO,OO′-bis(1,1-dimethylethyl) ester.

### Embodiment 9

The method of any one of the previous embodiments, wherein the composition comprises at least 0.1 and no more than 5 parts peroxide per 100 parts of the amorphous fluoropolymer.

### Embodiment 10

The method of any one of the previous embodiments, wherein the Type II coagent comprises at least one of(i) diallyl ether of glycerin, (ii) triallylphosphoric acid, (iii) diallyl adipate, (iv) diallylmelamine and triallyl isocyanurate, (v) tri(methyl)allyl isocyanurate, (vi) tri(methyl)allyl cyanurate, (vii) poly-triallyl isocyanurate, (viii) xylylene-bis(diallyl isocyanurate), and (ix) combinations thereof.

### Embodiment 11

The method of any one of the previous embodiments, wherein the composition comprises from 0.1 to 10 parts by weight of a Type II coagent per 100 parts of the amorphous fluoropolymer.

### Embodiment 12

The method of any one of the previous embodiments, wherein the composition is disposed as a layer on a substrate.

### Embodiment 13

The method of embodiment 12, wherein the layer has a dried thickness from at least 10 microns to at most 300 microns.

### Embodiment 14

The method of any one of embodiments 12-13, wherein the substrate comprises at least one of carbon steel, stainless steel, and aluminum.

### Embodiment 15

The method any one of the previous embodiments, wherein the curable composition further comprises a filler.

### Embodiment 16

The method of any one of the previous embodiments, further comprising 50-90 by wt % of a solvent versus the total weight of the composition.

### Embodiment 17

The method of any one of the previous embodiments, wherein at least one of the peroxide or the Type II coagent absorbs a wavelength of the actinic radiation.

### Embodiment 18

The method of any one of the previous embodiments, wherein the actinic radiation comprises at least one of ultraviolet radiation, visible radiation, infrared radiation, and combinations thereof.

### Embodiment 19

The method of any one of the previous embodiments, wherein the intensity of actinic radiation is from 0.2 to 10 watts/cm².

### Embodiment 20

The method of any one of the previous embodiments, wherein during the exposure to actinic radiation, the composition is exposed to temperatures no higher than 250° C.

### Embodiment 21

The method of any one of the previous embodiments, wherein the method is performed at ambient pressure.

### Embodiment 22

The method of any one of the previous embodiments, wherein the composition is exposed to actinic radiation in an environment substantially free of oxygen.

### Embodiment 23

The method of any one of the previous embodiments, wherein the actinic radiation utilizes mercury bulbs.

### Embodiment 24

The method of any one of the previous embodiments, wherein the actinic radiation utilizes light emitting diode bulbs.

### Embodiment 25

The method of any one of the previous embodiments, wherein the actinic radiation comprises at least one wavelength between 200-600 nm.

### Embodiment 26

The method of any one of the previous embodiments, further comprising contacting the partially cured composition to thermal energy.

### Embodiment 27

A cured article made by the method of any one of embodiments 1-26.

### Embodiment 28

A fluoroelastomer coating comprising: a peroxide cured fluoroelastomer, substantially free of a photoinitiator selected from a Type I photoinitiator, a Type II photoinitiator, and a 3-component electron transfer initiator system, wherein the fluoroelastomer coating has a thickness of at least 10 microns and at most 300 microns.

### EXAMPLES

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Mo., or may be synthesized by conventional methods.

The following abbreviations are used in this section: g=grams, μm=micrometers, mil-thousandths of an inch, ft=feet, m=meter, wt %/=percent by weight, min=minutes, h=hours, ppm=parts per million. Abbreviations for materials used in this section, as well as descriptions of the materials, are provided in Table 1.

### Materials

TABLE 1

| Material | Details |
|---|---|
| Fluoro- | An amorphous fluoropolymer derived from about 26.5% |
| polymer A | of TFE, 36.5% of HFP and 37% of VDF by weight with |
| | 0.18% of bromine and 0.15% of iodine by weight, 69.8 |
| | wt % fluorine content, and Mooney Viscosity |
| | ML1 + 10 @ 121° C. of 36. |
| Fluoro- | An amorphous fluoropolymer derived from about 16% |
| polymer B | of TFE, 31% of VDF and 53% of CF2═CFO(CF2)3OCF3 |
| | by weight with 0.12% of bromine, 67.1% fluorine content, |
| | and Mooney Viscosity ML1 + 10 @ 121° C. of 95. |
| TAIC | Trially isocyanurate, ≥98%, a coagent, available from |
| | TCI America, Portland, OR, USA |
| Peroxide I | 2,5-Bis(tert-butylperoxy)-2,5-dimethylhexane, 50% active |
| | on a mineral carrier, available from Vanderbilt Chemicals, |
| | Norwalk, CT, under the trade designation |
| | “VAROX DBPH-50”. |
| Peroxide II | 2,5-Bis(tert-butylperoxy)-2,5-dimethylhexane, 90% |
| | active, available from Sigma-Aldrich under the trade |
| | designation “LUPEROX 101”. |
| MeOH | Methanol, available from Sigma-Aldrich |
| MEK | 2-Butanone, available from EMD Millipore Corporation, |
| | Billerica, MA, USA |
| N990 | Carbon black, available under the trade designation |
| | “N990” from Cancarb, Medicine Hat, AB, CA |
| ZnO | Zinc Oxide, available from Horsehead Corporation, |
| | Monaca, PA, USA |
| Polyimide | 5 mil (127 micron) HN polyimide film, from AMD |
| film | Converting & Label, LLC, Waukesha, WI |

Compounding

100 g batches of the fluoropolymers indicated in Table 2 were compounded on an open mill with or without coagent, with or without peroxide, and with or without additives ZnO and N990, as indicated in Table 2 and Table 3.

Characterization Methods

Gel Test:

The gel test was done by measuring the mass of a cured sample (approximately 0.2 g) and then placing it between pieces of wire mesh (square weave, stainless steel type 304, woven construction, 325 mesh, 0.0014 inch (35 micron) wire with a 0.0017 inch (43 micron) opening), available as item number 3888704810 from McNICHOLS CO., Minneapolis, Minn., USA, and soaking in 10 g of MEK for 24 h. After soaking, the sample was then removed from the solvent and the solvent was dried from the surface of the sample. The mass of the sample was measured. The percent gel was calculated as the ratio of the post-soaking mass to the pre-soaking mass, multiplied by 100%.

### Examples 1 Through 4 (EX-1 Through EX-4) and Counter Examples 1 Through 3 (CE-1 Through CE-3)

30 g batches of compounds described in Table 2 were dissolved in 63 g MEK and 7 g MeOH. The mixtures were mixed on rollers for 24 h, and then coated on polyimide film using a coating bar gate with a nominal coating thickness of 30 mil (762 μm). The coating was placed in a hood for 30 min, and then was put in a 60° C. oven for 10 min to evaporate solvents. The uncured coating was exposed to actinic radiation using a UV-Web equipped with an UV mercury lamp with D-bulb at 100% power, 600 watts, available under the trade designation “F600” from Heraeus, Hanau, Germany, for five passes at 10 ft/min (3.0 m/min) under an N₂ purge during which the O₂ concentration was measured to be 30±5 ppm, for a total UV-exposure time of 30 sec. The cured coating was peeled off the polyimide film, and then tested by the Gel Test described above.

TABLE 2
UV Curing Conditions: H-bulb, 10
ft/min, 30 ± 5 ppm O₂ (N₂ purge)

| | EX-1 | EX-2 | EX-3 | EX-4 | CE-1 | CE-2 | CE-3 |
|---|---|---|---|---|---|---|---|
| Fluoropolymer B | | | 100 | | | | |
| Fluoropolymer A | 100 | 100 | | 100 | 100 | 100 | 100 |
| TAIC 90% | 2.5 | 2.5 | 1.8 | 2.5 | | 2.5 | |
| Peroxide I | | | 2.5 | | | | |
| Peroxide II | 2.5 | 2.5 | | 2.5 | | | 2.5 |
| ZnO | | | 5 | | | | |
| N990 | 30 | 1 | 50 | | | | |
| % solution in MEK + | 30 | 30 | 20 | 30 | 30 | 30 | 30 |
| MeOH | | | | | | | |
| % Gel after 24 h in | 93 | 83 | 97 | 73 | 0 | 0 | 0 |
| MEK | | | | | | | |

### Counter Examples 4 Through 7 (CE-4 Through CE-7)

30 g batches of compounds described in Table 3 were dissolved in 63 g MEK and 7 g MeOH. The mixtures were mixed on rollers for 24 h, and then coated on polyimide film using a coating bar gate with a nominal coating thickness of 30 mil (762 μm). The coating was placed in a hood for 30 min, and then was put in a 60° C. oven for 10 min to evaporate solvents. The heat cured samples (CE-4 through CE-7) were cured at 190° C. for 2 min in a batch oven available under the trade designation “FED 115-UL E2” from BINDER, Tuttingen, Germany, under the atmosphere indicated in Table 3. The cured coating was peeled off the polyimide film, and then tested by the Gel Test described above.

TABLE 3

| | Oven Cure 190° C., 2 min | | | |
|---|---|---|---|---|
| | in air | | in N₂ | |
| Counter Example Number | CE-4 | CE-5 | CE-6 | CE-7 |
| Fluoropolymer A | 100 | 100 | 100 | 100 |
| TAIC 90% | 2.5 | 2.5 | 2.5 | 2.5 |
| Peroxide II | 2.5 | 2.5 | 2.5 | 2.5 |
| N990 | | 30 | | 30 |
| % solution in MEK + MeOH | 30 | 30 | 30 | 30 |
| % Gel after 24 h in MEK | 0 | 0 | 0 | 19 |

Foreseeable modifications and alterations of this invention will be apparent to those skilled in the art without departing from the scope and spirit of this invention. This invention should not be restricted to the embodiments that are set forth in this application for illustrative purposes. To the extent that there is any conflict or discrepancy between this specification as written and the disclosure in any document mentioned or incorporated by reference herein, this specification as written will prevail.

1. A method of at least partially curing a fluoroelastomer, the method comprising:
(i) obtaining a composition comprising:
(a) an amorphous fluoropolymer having a plurality of cure sites wherein the cure sites comprise iodine, bromine, nitrile, or combinations thereof; and
(b) a peroxide cure system comprising a peroxide and a Type II coagent; wherein the composition is substantially free of a photoinitiator, wherein the photoinitiator is selected from a Type I photoinitiator, a Type II photoinitiator, and a 3-component electron transfer initiator system; and
(ii) exposing at least a surface of the composition to actinic radiation.

2. The method of claim 1, wherein the composition further comprises carbon black.

3. The method of claim 1, wherein the amorphous fluoropolymer comprises at least 0.1 weight % of iodine versus the total weight of the amorphous fluoropolymer.

4. The method of claim 1, wherein the amorphous fluoropolymer comprises at least 0.1 weight % of bromine versus the total weight of the amorphous fluoropolymer.

5. The method of claim 1, wherein the amorphous fluoropolymer is partially fluorinated.

6. The method of claim 1, wherein the amorphous fluoropolymer is a copolymer of wherein the amorphous fluoropolymer comprises (i) a copolymer comprising hexafluoropropylene, tetrafluoroethylene, and vinylidene fluoride monomeric units; (ii) a copolymer comprising hexafluoropropylene and vinylidene fluoride monomeric units, (iii) a copolymer comprising vinylidene fluoride and perfluoromethyl vinyl ether monomeric units, (iv) a copolymer comprising vinylidene fluoride, tetrafluoroethylene, and perfluoromethyl vinyl ether monomeric units, (v) a copolymer comprising vinylidene fluoride, tetrafluoroethylene, and propylene monomeric units, (vi) a copolymer comprising ethylene, tetrafluoroethylene, and perfluoromethyl vinyl ether monomeric units, and (vii) blends thereof.

7. The method of claim 1, wherein the amorphous fluoropolymer is perfluorinated.

8. The method of claim 1, wherein the peroxide is at least one of 2,5-dimethyl-2,5-di(t-butylperoxy)hexane; dicumyl peroxide; di(2-t-butylperoxyisopropyl)benzene; dialkyl peroxide; bis (dialkyl peroxide); 2,5-dimethyl-2,5-di(tertiarybutylperoxy)3-hexyne; dibenzoyl peroxide; 2,4-dichlorobenzoyl peroxide; tertiarybutyl perbenzoate; α,α′-bis(t-butylperoxy-diisopropylbenzene); t-butyl peroxy isopropylcarbonate, t-butyl peroxy 2-ethylhexyl carbonate, t-amyl peroxy 2-ethylhexyl carbonate, t-hexylperoxy isopropyl carbonate, di[1,3-dimethyl-3-(t-butylperoxy)butyl] carbonate, carbonoperoxoic acid, or O,O′-1,3-propanediyl OO,OO′-bis(1,1-dimethylethyl) ester.

9. The method of claim 1, wherein the Type II coagent comprises at least one of (i) diallyl ether of glycerin, (ii) triallylphosphoric acid, (iii) diallyl adipate, (iv) diallylmelamine and triallyl isocyanurate, (v) tri(methyl)allyl isocyanurate, (vi) tri(methyl)allyl cyanurate, (vii) poly-triallyl isocyanurate, (viii) xylylene-bis(diallyl isocyanurate), and (ix) combinations thereof.

10. The method of claim 1, wherein the composition comprises from 0.1 to 10 parts by weight of a Type II coagent per 100 parts of the amorphous fluoropolymer.

11. The method of claim 1, wherein the composition is disposed as a layer on a substrate.

12. The method of claim 11, wherein the layer has a dried thickness from at least 10 microns to at most 300 microns.

13. The method of claim 1, wherein at least one of the peroxide or the Type II coagent absorbs a wavelength of the actinic radiation.

14. A cured article made by the method of claim 1.

15. A fluoroelastomer coating comprising: a peroxide cured fluoroelastomer, substantially free of a photoinitiator selected from a Type I photoinitiator, a Type II photoinitiator, and a 3-component electron transfer initiator system, wherein the fluoroelastomer coating has a thickness of at least 10 microns and at most 300 microns.

16. The method of claim 1, wherein the composition comprises at least 0.1 and no more than 5 parts peroxide per 100 parts of the amorphous fluoropolymer.

17. The method of claim 1, wherein during the exposure to actinic radiation, the composition is exposed to temperatures no higher than 250° C.

18. The method of claim 1, wherein the composition is exposed to actinic radiation in an environment substantially free of oxygen.
